(19) United States
(12) Patent Application Publication
(10) Pub. No.: US 2003/0167468 A1
(43) Pub. Date: Sep. 4, 2003

(54) Video-processing method and system for enriching the content of a tv program

(76) Inventors: Laurent Hermann, Le Kremlin-Bicetre (FR); Laurent Michel Olivier Duquesnois, San Mateo, CA (US); Guillaume Brouard, Paris (FR)

Correspondence Address: Corporate Patent Counsel, Philips Electronics North America Corporation, 580 White Plains Road, Tarrytown, NY, 10591, US

(21) Appl. No.: 10/297,358

(22) PCT Filed: Apr. 8, 2002
(86) PCT No.: PCT/IB02/01254

(30) Foreign Application Priority Data
Apr. 10, 2001 (FR) 01/04863

(51) Int. Cl. G06F 13/00; H04N 5/445

(52) U.S. Cl. 725/61; 348/564

(57) ABSTRACT

The invention relates to a video-processing method and system for enriching one or several primary video signals by association of additional data in a video scene encoded in accordance with the MPEG4 standard, this associating allowing simultaneous display of a primary video signal and said additional data, and enabling a user to interact with and access the contents of said additional data.

The invention relates to a video-processing system comprising means for associating additional data with primary video signals, said association means generating a set of data transmitted after multiplexing, via a transmission channel, to a user having the disposal of means for visualizing said transmitted data.

The invention also relates to a video-processing method comprising a step of associating additional data with primary video signals, said association step generating a set of data transmitted after a multiplexing step, via a transmission channel, to a user having the disposal of means for visualizing said transmitted data.

This invention finds numerous applications in systems for broadcasting video programs, particularly at the level of TV program broadcasters, when the content of a video program must be enriched by additional data.

PCT application WO 00/33197 describes a method and an apparatus with which additional data can be associated with a sequence of temporal data, which data are linked with the contents of said sequence of temporal data. To this end, each additional data is linked with said sequence of data by a starting hour and an ending hour, the starting hour indicating the instant when the additional data is associated and the ending hour indicating the instant after which said additional data is no longer associated. The additional data preferably correspond to commercials on which the user may interact when these are displayed on a screen, after reception, with the contents of said sequence of data.

The method of associating additional data described in the prior-art document has a certain number of limitations.

First of all, in the method described in the prior-art document, each additional data item is temporally positioned with respect to the data sequence. In the case where the data sequence is subjected to a temporal shifting, notably when these additional data must be associated with the content of a TV program subjected to a program delay, all the starting and ending hours of each additional data item must be recomputed, which requires the use of costly control means.

On the other hand, the method of associating additional data in the data sequence is characterized at the level of the displayed final video content by overlaying an additional data item in the contents of said data sequence. By clicking on this additional data item, the user triggers the opening of a new display zone with the detailed content of said additional data item. This mode of displaying an additional data item is not very practical for the user because, on the one hand, the opening of the new display zone diminishes the zone for displaying the contents of said data sequence to an equal extent and, on the other hand, the user must manually control the display so as to optimally organize the display zones which will be more numerous as he clicks on a large number of additional data.

Finally, in the method according to the prior-art document, an additional data item may point at an Internet site informing the user in a more precise manner about the object of said additional data item. This has the drawback that the user is obliged to have such an Internet access so as to satisfy his request for complementary information.

Moreover, the method according to the prior-art document leads to the systematic display of additional data in the contents of the data sequence, whether or not desired by the user. Consequently, the user is permanently subjected to this display of additional data, which he does not control and may strongly disturb him if he only wishes to see the contents of the data sequence.

It is an object of the invention to remedy these limitations to a large extent by providing a novel video-processing system for enriching one or several primary video signals by association of additional data, this association allowing simultaneous display of a primary video signal and said additional data and enabling a user to interact with the contents of said additional data.

To this end, the invention is characterized in that the video-processing system comprises means for creating a video scene from a predefined scene description having a hierarchic structure, and a set of scene elements arranged in accordance with said scene description, said set of scene elements comprising said primary video signals and particularly active scene elements associated with events which can be triggered by said user, said scene description and said scene elements constituting said additional data.

In accordance with another characteristic feature, the invention is characterized in that a sub-set of active scene elements defines a graphic menu displayed on said visualization means, enabling said user to interact in said video scene by accessing other scene elements.

In accordance with another characteristic feature, the invention is characterized in that the association of certain scene elements with said primary video signals is such that they are visualized semi-transparently with respect to said primary video signals.

According to the invention, and in contrast to the prior-art document in which the additional data are considered and associated independently of one another with the primary video signal, the additional data form a video scene constituted by scene elements arranged in accordance with a scene description describing the relations existing between the different scene elements. This allows the video-processing system to easily manipulate a single entity of additional data for association with a primary video signal.

Advantageously, the video scene comprising the additional data is encoded in accordance with the MPEG4 video ISO/IEC14496-2 standard, and particularly the description of the scene is encoded in accordance with the BIFS format (BInary Format for Scene description). This not only allows a definition of the characteristics for each scene element such as its position in the scene, the visual appearance, the possibility of interaction, but also of interlinking different scene elements.

These scene elements correspond, on the one hand, to data whose contents are linked or not linked with that of the primary video signal and, on the other hand, to data allowing definition of a graphic menu displayed on said visualization means.

After transmission of the primary video signal and said video scene to a user, the latter visualizes the scene elements by using said menu. The action of the user, for example, generated by a mouse click on an element of the key type constituting said menu triggers the display of a scene element which may itself be the object of a new interaction by said user in order to display a new scene element. The menu thus enables the user to navigate in the video scene in accordance with a certain branched system defined by the scene description and thus have access to all the scene elements transmitted by the video-processing system. As all the scene elements are transmitted to the user by the video-processing system, the application at the user's level is completely autonomous to the extent that it is not necessary to collect scene elements via another transmission network.

In contrast to the prior-art method, said menu enables the user to choose the scene elements which he wants to visualize.

The scene elements are visualized on said visualization means simultaneously with the content of a primary video signal. To this end, the scene elements are inserted semi-transparently in the content of said primary video signal so as to allow display of said elements and the content of said video signal in the same zone of visualization.

In accordance with another characteristic feature, the invention is characterized in that the video-processing system comprises means for video encoding said primary video signals for generating video scene elements of a reduced format.

This allows definition of scene elements having a reduced format and being temporally synchronized with the primary video signals. Moreover, in the case where several primary video signals are transmitted to the user, but only a single primary video signal is visualized, the user may nevertheless visualize, in a reduced format, the contents of the video signals which are not displayed full screen by means of said scene elements of a reduced format.

In accordance with another characteristic feature, the invention is characterized in that the video-processing system comprises means for updating said video scene so as to particularly take the change of state of certain scene elements into account.

In accordance with another characteristic feature, the invention is characterized in that the video-processing system comprises means for periodically transmitting said scene description and said scene elements via said transmission channel.

The invention may be particularly used for enriching the content of a video signal corresponding to a direct-broadcast event and is provided with means for updating the characteristics of certain scene elements so as to enable the user to permanently have access to topical data, but also to information about a change of characteristics of a scene element in particular.

As the invention is particularly dedicated to transmissions of the broadcast type to a group of users, this periodical transmission enables a user, after reception of said scene description, to visualize scene elements comprising information complementary to the content of the displayed main program.

These and other aspects of the invention are apparent from and will be elucidated, by way of non-limitative example, with reference to the embodiment(s) described hereinafter.

In the drawings

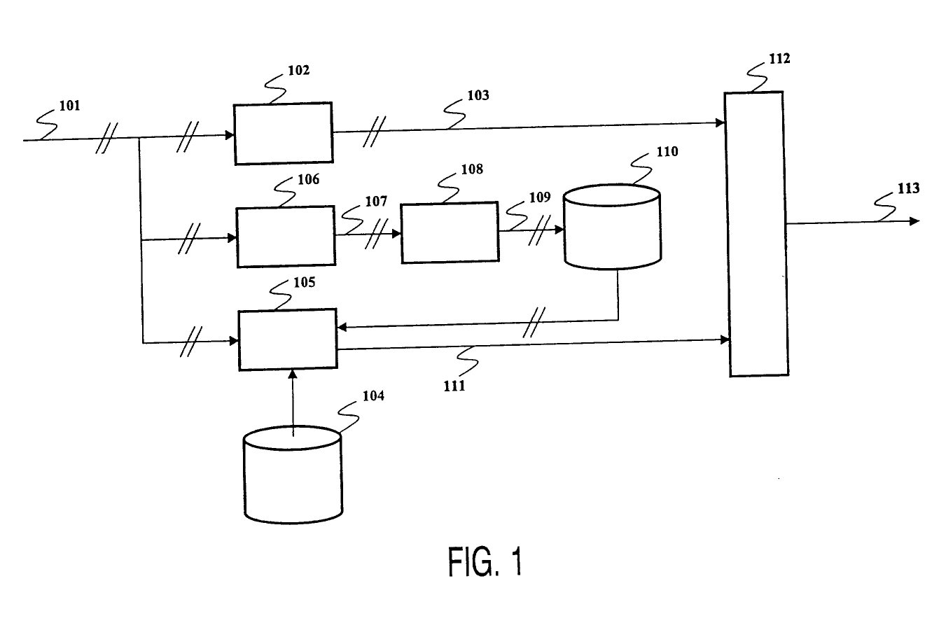

FIG. 1 shows a first video-processing system according to the invention,

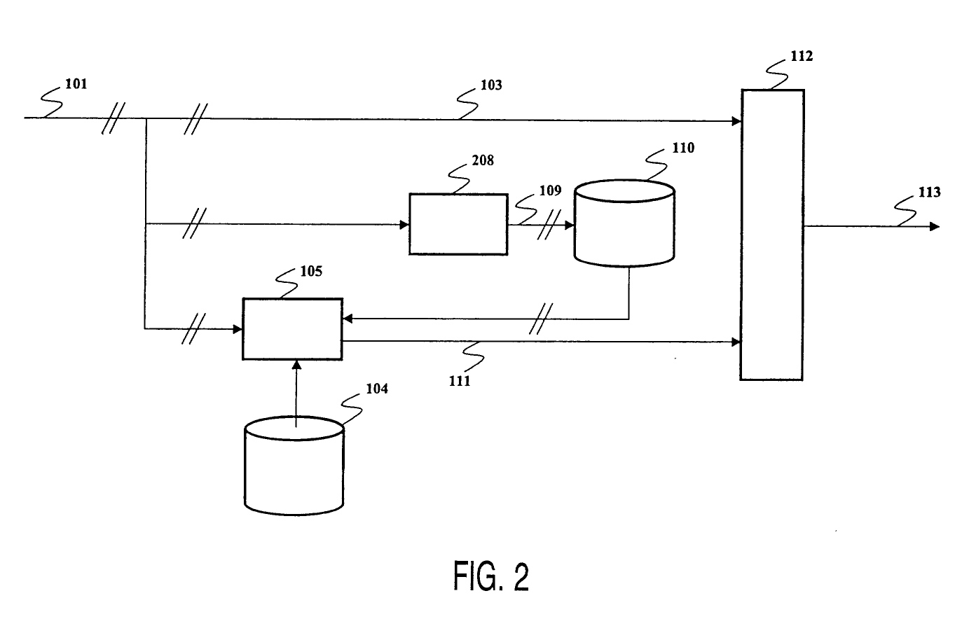

FIG. 2 shows a second video-processing system according to the invention,

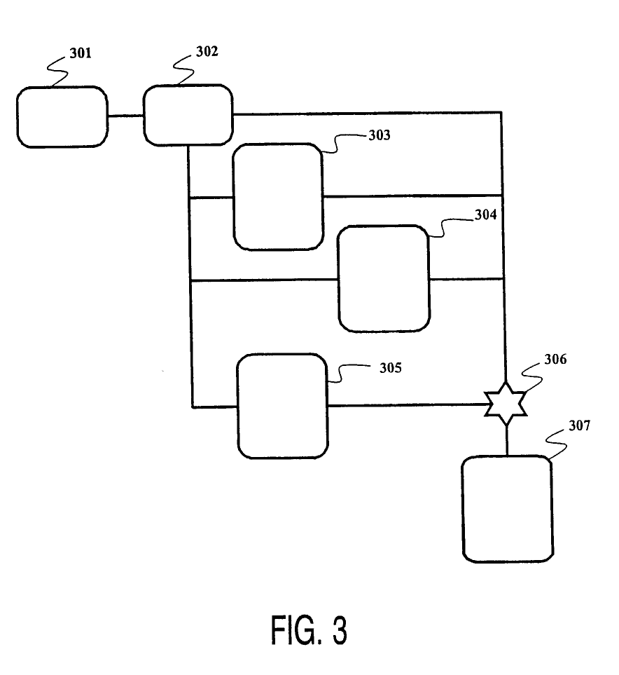

FIG. 3 shows a branch structure with which the additional data are controlled by a video-processing system according to the invention,

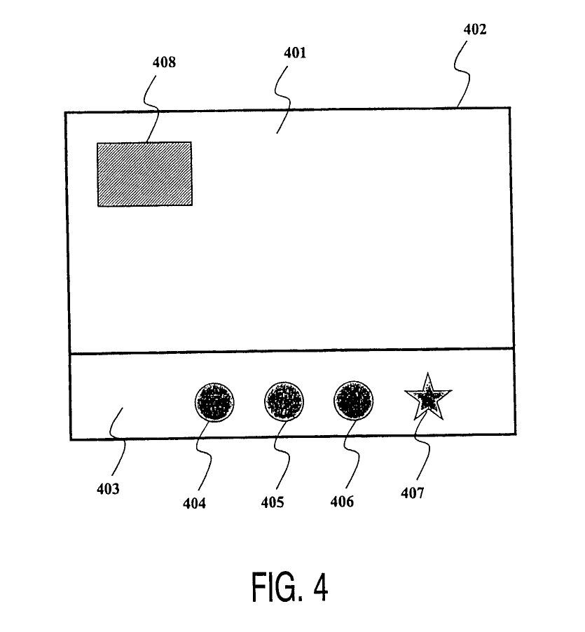

FIG. 4 shows the display of data which are additional to the content of a main program according to the invention.

FIG. 1 shows a video-processing system according to the invention for enriching the contents of primary video signals by association of additional data, before transmission to a user. By way of non-limitative example, the context may relate to the direct broadcast of a Formula 1 race course. The video-processing system according to the invention is used to enable a user to obtain complementary information about this sports event displayed on his television set (TV), by way of interaction from this TV, while simultaneously displaying a main program relating to this race course on his full TV screen.

At the input, the processing system receives a set of primary video signals 101 from, for example, video cameras positioned at several sites of the circuit. These signals correspond to the different main programs with which additional data are associated by the video-processing system according to the invention. They are encoded in accordance with the MPEG2 standard by the encoding unit 102 generating the encoded video signals 103. The invention may of course also be used in the case where there is only one main program.

The additional data associated with the signal 103 are controlled in such a way that said additional data and said main programs constitute a video scene encoded in accordance with the MPEG4 standard. This scene is characterized in that it provides access, at the user's level, to scene elements via a menu which itself forms part of the video scene. This video scene is constituted by a predefined scene model stored in the storage unit 104, by scene elements from the signals 101 after processing, and by said main programs.

The scene model particularly comprises all the scene elements which can be put at the user's disposal before said sports event. For example, these scene elements relate notably to data of the image type (e.g. photos of the F1 pilots), video type (e.g. videoclips of test rides), graphic type (e.g. F1 race course map), text type (e.g. curriculum of the drivers). These elements also relate to data of the graphic type (e.g. keys) defining said menu.

The scene model also comprises the description of the scene, i.e. the hierarchic structure in accordance with which the different scene elements are controlled. This scene description is encoded in accordance with the BIFS format (BInary Format for Scene description). From this description of the scene, the different scene elements are individually characterized by a set of fields (e.g. position in the image, form, appearance, interaction ...) but they are also interlinked by means of the branches defined by the hierarchic structure.

When scene elements have interaction characteristics, an action by the user on this scene element enables him to trigger an event. This is the case with the scene elements defining the buttons of the menu which, after a user action (e.g. a click with a mouse cursor) triggers the display of another scene element on the user's TV (e.g. a display of the classification), which other scene element may itself have an interaction characteristic enabling the user to trigger another display event (e.g. the leader's curriculum). In this way, the user can navigate through the set of scene elements of the video scene associated with a main program in accordance with a predefined branch structure, with the object of obtaining complementary information about said sports event.

The video scene also comprises scene elements created from video signals 101, that is, scene elements which are temporally synchronized with said signals 101. To the extent where these scene elements comprise complementary information about the contents of the main program, the invention provides encoding means 106 and 108 with which encoded video signals 109 of a reduced format can be generated. To this end, the processing block 106 performs a sub-sampling operation in the pixel domain of the different signals 101 so as to generate sub-sampled video signals 107. The signals 107 are subsequently encoded in accordance with the MPEG4 ISO/IEC 14496-2 standard by the encoder 108 generating said signals 109, which are possibly stored temporarily in the storage unit 110.

The different scene elements stored in the storage units 104 and 110 are controlled by the unit 105 for editing the scene. The unit 105 generates the video scene 111 including, in accordance with the predefined scene description, all the additional data to be associated with the main programs conveyed by the video signal 103.

The scene-editing unit 105 also takes the main programs conveyed by the signal 103 into account so as to integrate them in the MPEG4 scene conveyed by the signal 111. To this end, the scene description associates them with a scene element each referring, for example, by means of a data cursor to one of the video signals 103 encoded in accordance with the MPEG2 standard. At the user's level, the latter chooses, from the set of main programs in the scene, the program which he wishes to effectively display on his TV and in whose contents the additional data are also displayed.

In a variant (not shown) of the invention, scene elements are directly supplied from the contents of Internet sites remote from the video-processing system according to the invention.

This scene-editing unit is also used for updating the characteristic features of certain scene elements. Indeed, the invention provides the possibility of sending scene elements of the “warning” type which have the particular feature that they signalize to a user that an important event has occurred during the race course. This warning-type element must thus be updated as soon as an important event occurs by notably modifying its appearance but also by updating the event which he must trigger subsequent to a user action (e.g. a click on a menu button indicates to the user that an important event appears which event corresponds to the display of a videoclip showing an accident). Other scene elements may of course also be updated by the unit 105, particularly scene elements of the text type such as text-type scene elements relating to the classification of the Formula I drivers after a number of laps. To update the video scene 111, the unit 105 uses MPEG4 mechanisms provided for this purpose and known to those skilled in the art, particularly by using the BIFS commands allowing descriptions and updates of all or part of the elements of an MPEG4 video scene.

As the processing system according to the invention is particularly used within a context of broadcasting TV programs to a group of users, the set of scene elements as well as the scene description stored in the storage unit 104 are not permanently transmitted so as not to generate a stream of data transmitted in a too high passband. As these data are nevertheless necessary when a user wishes to access the additional data relating to the main program, particularly for displaying the scene elements constituting the menu, the processing system according to the invention also comprises means (not shown in FIG. 1) allowing a periodical transmission of the set of scene elements as well as the description of the scene stored in the storage unit 104. This periodical transmission is of the RAP type (Random Access Point). In this way, a user wishing to access the additional data will maximally wait for a period between two periodical transmissions before he receives the description of the scene and the scene elements constituting this description, and watch said scene on his TV.

It should be noted that the video scene carried by the signal 101 not only comprises video scene elements as described hereinbefore but also scene elements of the audio type stored in the storage unit 104.

Finally, the video scene 111 thus created and representing the additional data and the signal 103 corresponding to the main program are multiplexed by the multiplexing unit 112 in order to generate the signal 113 transmitted to a user via a communication channel.

FIG. 2 describes a video-processing system according to the invention which is identical to that described with reference to FIG. 1 but processes primary video signals of a different nature. Indeed, the video signals 101 are already encoded, for example, in accordance with the MPEG2 video compression standard. This video-processing system is more particularly dedicated for use by a service provider.

Concerning the means used, it should first of all be noted that the encoding block 102 described with reference to FIG. 1 is omitted in so far as the signals 101 have already been encoded in accordance with the MPEG2 standard.

The other changes with respect to FIG. 1 concern the means for generating video signals 109 of a reduced format, obtained from said video signals 101. Indeed, transcoding means 208 are used for generating said signals 109. These means 208 may particularly consist of a cascade arrangement of an MPEG2 decoder generating a video signal decoded in the pixel domain, means for sub-sampling said decoded video signal for generating a decoded video signal of a reduced format, and an MPEG4 encoder generating a video signal 109 of a reduced format.

The means for creating the video scene from scene elements 109 and scene elements stored in the storage unit 104 are identical to those described with reference to FIG. 1.

FIG. 3 shows, by way of non-limitative example, the branch structure of the menu to which the user has access so as to enable him, via a user action, to visualize scene elements comprising complementary information about the content of the main program. This branch structure complies with the characteristics of the predefined description of the scene, stored in the storage unit 104 and used by the video-processing system according to the invention for generating the MPEG4 video scene. Complementary to the explanations given hereinbefore, this scene relates to the content of said sports event.

This branch structure comprises a first level 301 by which the user only visualizes the content of a main program on the full screen of his TV. When he wishes to access additional information relating to the content of said main program, the level 302 displays the menu, allowing interaction with the different scene elements. In the relevant case, this menu comprises four branches enabling the user to access different types of scene elements. A first branch relates to the level 303 which displays a data item of the video type showing, for example, a reduced format video of another view of the Formula 1 circuit, which video is superimposed on the content of said main program. A second branch relates to the level 304 which displays data of the text type giving information about, for example, the classification of the drivers after a number of laps, which text data are superimposed on the content of said main program. A third branch relates to the level 305 which displays data of the graphic type giving information about, for example, the positions of the racing cars in the circuit, which graphic data are superimposed on the content of said main program. A fourth branch relates to the level 306 which displays scene elements of a different type superimposed on the content of said main program, the type being different in accordance with the use of the associated scene element, i.e. of the video type for showing the user, for example, a racing car crash which has occurred, or of the image type for displaying, for example, a portrait of the new leader of the race. The level 306 is particularly dedicated to additional data having a warning character. It should be noted that it is possible to display the scene elements relating to the levels 303, 304 and 305 simultaneously with the scene elements relating to the level 307, resulting in the display level 307.

FIG. 4 shows, in a non-limitative manner, the simultaneous display of a main program 401 and a set of additional data on a TV denoted by the reference numeral 402 after reception and decoding of a signal created by the video-processing system according to the invention. Said decoding is effected by means of an MPEG4 decoder implemented, for example, in a receiver of the set top box type.

The additional data first define a zone of the menu 403 enabling a user to interact with the video contents by accessing different scene elements by means of buttons 404-405-406 and 407. Said buttons 404-405-406 and 407 allow access to the visualization levels 303-304-305 and 306, respectively, as described with reference to FIG. 3.

By clicking on a button, for example, via the cursor of a mouse, or by using the displacement arrows on the TV remote control unit, followed by a validation of the position, a display event is triggered, resulting in the display of a scene element 401 semi-transparently with the content of the main program 401.

A click on the button 404 displays, for example, a reduced video format of another view of the circuit. A click on the button 405 displays text-type data giving information about, for example, the classification of the Formula 1 drivers. A click on the button 406 displays the graphic-type data giving information about, for example, the positions of the racing cars in the circuit. By clicking on the button 407, data of a different type are displayed, said type being a function of the type of the associated scene element during composition of the scene. The button 407 is particularly dedicated to inform the user of an event of the warning type, for example, by making the user click on it so as to get informed about the content of the warning.

As regards the use of hardware in a video-processing system, particularly signal processors are used which perform the different operations and processing steps described hereinbefore on the different data by executing sets of instructions stored in the memory and particularly obtained after compilation of a computer program.

1. A video-processing system comprising means for associating additional data with primary video signals, said association means generating a set of data transmitted after multiplexing, via a transmission channel, to a user having the disposal of means for visualizing said transmitted data, characterized in that said video-processing system comprises means for creating a video scene from a predefined scene description having a hierarchic structure, and a set of scene elements arranged in accordance with said scene description, said set of scene elements comprising said primary video signals and particularly active scene elements associated with events which can be triggered by said user, said scene description and said scene elements constituting said additional data.

2. A video-processing system as claimed in claim 1, characterized in that a subset of active scene elements defines a graphic menu displayed on said visualization means, enabling said user to interact in said video scene by accessing other scene elements.

3. A video-processing system as claimed in claim 2, characterized in that the association of certain scene elements with said primary video signals is such that they are visualized semi-transparently with respect to said primary video signals.

4. A video-processing system as claimed in claim 3, characterized in that it comprises means for video encoding said primary video signals for generating video scene elements of a reduced format.

5. A video-processing system as claimed in claim 4, characterized in that it comprises means for updating said video scene so as to particularly take the change of state of certain scene elements into account.

6. A video-processing system as claimed in claim 5, characterized in that it comprises means for periodically transmitting said scene description and said scene elements via said transmission channel.

7. A video-processing method comprising a step of associating additional data with primary video signals, said association step generating a set of data transmitted after a multiplexing step, via a transmission channel, to a user having the disposal of means for visualizing said transmitted data, characterized in that said video-processing method comprises a step of creating a video scene from a predefined scene description having a hierarchic structure, and a set of scene elements arranged in accordance with said scene description, said set of scene elements comprising said primary video signals and particularly active scene elements associated with events which can be triggered by said user, said scene description and said scene elements constituting said additional data.

8. A video-processing method as claimed in claim 7, characterized in that a subset of active scene elements defines a graphic menu displayed on said visualization means, enabling said user to interact in said video scene by accessing other scene elements.

9. A video-processing method as claimed in claim 8, characterized in that the association of certain scene elements with said primary video signals is such that they are visualized semi-transparently with respect to said primary video signals.

10. A video-processing method as claimed in claim 9, characterized in that it comprises a step of video encoding said primary video signals for generating video scene elements of a reduced format.

11. A video-processing method as claimed in claim 10, characterized in that it comprises a step of updating said video scene so as to particularly take the change of state of certain scene elements into account.

12. A video-processing method as claimed in claim 1, characterized in that it comprises a step of periodically transmitting said scene description and said scene elements via said transmission channel.

13. A digital signal for television encoded in accordance with the MPEG4 starard, characterized in that it particularly includes video signal elements encoded in accordance with the MPEG2 standard, video signal elements of a reduced format, encoded in accordance with the MPEG4 standard obtained from said video signal elements encoded in accordance with the MPEG2 standard, signal elements of a graphic type, signal elements of a text type, the set of said signal elements being linked by a scene description for simultaneously accessing the visual contents of said video signals encoded in accordance with the MPEG2 standard and the visual contents of other signal elements by interaction with signal elements allowing access to the visual contents of signal elements belonging to said set.

14. A computer program product for a video-processing system, said computer program comprising a sequence of instructions which, when loaded into said video-processing system, allow said video-processing system to perform the different steps of said video-processing method as claimed in claims 7 to 12.
